(19) United States
(12) Patent Application Publication
(10) Pub. No.: US 2018/0371369 A1
(43) Pub. Date: Dec. 27, 2018

(54) FABRIC TREATMENT

(71) Applicant: The Procter & Gamble Company, Cincinnati, OH (US)

(72) Inventors: Eva Maria PEREZ-PRAT VINUESA, Newcastle upon Tyne (GB); Samuel Kimani NJOROGE, Cincinnati, OH (US); Alan Edward SHERRY, Newport, KY (US)

(21) Appl. No.: 16/013,975

(22) Filed: Jun. 21, 2018

Related U.S. Application Data
(60) Provisional application No. 62/522,828, filed on Jun. 21, 2017.

(51) Int. Cl. C11D 3/32; C11D 3/48; C11D 3/20; C11D 1/14; C11D 11/00

(52) U.S. Cl. CPC C11D 3/32; C11D 3/48; C11D 11/0017; C11D 3/2082; C11D 1/146; C11D 3/2086

(57) ABSTRACT

The present disclosure relates to methods of treating a fabric by contacting the fabric with an aqueous liquor having a surfactant; an acidifying agent; and an amide and optionally an antimicrobial active. The fabric may be contacted with the aqueous liquor in a rinse step and/or in a pre-treatment step of a fabric laundering process.

### FIELD OF INVENTION

This invention relates to methods of treating fabrics and fabric laundering/washing processes.

### BACKGROUND OF THE INVENTION

Fabric laundering processes provide good soil and stain removal. There may also be a desire to provide an additional fabric treatment step in which the fabric is treated with a composition that may provide antimicrobial properties to the treatment water, to promote further cleaning benefits. Such compositions may be added as a pre-treatment step, prior to a laundering/wash step or as a post-treatment step, following a laundering/wash step. Such a treatment may be particularly useful where fabrics are prone to develop malodour, for example if the fabric is not dried immediately, or where fabrics are re-wet during use and may stay damp for some time: for example if wet, laundered fabrics may remain in a washing machine for some time prior to drying, for example over 20 minutes or longer prior to drying; if laundered fabrics will be line-dried in a warm, humid environment or indoors; or if the fabrics will be damp during use, such as towels or sportswear left prior to washing.

There is therefore a need for a fabric treatment that can be used to provide such an additional step that may provide improved cleaning as well as antimicrobial benefits. It has now been found that a treatment step in which fabrics are contacted with a composition comprising amides (which may be derived from renewable sources) may be incorporated into phase stable aqueous solutions to provide cleaning and potentiation of antimicrobial activity.

### SUMMARY OF THE INVENTION

The present disclosure attempts to solve one or more of the needs above by providing a method of treating a fabric, the method comprising contacting the fabric with an aqueous liquor comprising a surfactant; an acidifying agent; an amide of formula I:

R1-CO—NR2R3 (I)

wherein R1 is selected from the group consisting of linear or branched, substituted or unsubstituted C6-C12, each of R2 and R3 is independently selected from H, OH, a halogen, or C1-C6 linear or branched, substituted or unsubstituted hydrocarbyl groups; optionally an antimicrobial active; and water; wherein said liquor has a pH from about 3.0 to about 6.5, preferably from 3.5 to 6.

The aqueous liquor is preferably formed by adding to water a composition comprising the surfactant; acidifying agent; amide of formula I:

R1-CO—NR2R3 (I)

wherein R1 is selected from the group consisting of linear or branched, substituted or unsubstituted C6-C12, each of R2 and R3 is independently selected from H, OH, a halogen, or C1-C6 linear or branched, substituted or unsubstituted hydrocarbyl groups; water; and optional antimicrobial active; wherein said composition has a pH from about 1 to about 6, preferably from about 2.5 to about 5.0.

Preferably antimicrobial active is present. Preferably the weight ratio of acidifying agent to antimicrobial active is from about 0.2:1 to about 5:1. Preferably the weight ratio of surfactant to antimicrobial active is from about 0.1:1 to about 10:1. Preferably the weight ratio of antimicrobial active to amide of formula I is from about 0.2:1 to about 5:1.

### DETAILED DESCRIPTION OF THE INVENTION

Features and benefits of the disclosed invention will become apparent from the following description, which includes examples intended to give a broad representation of the invention. Various modifications will be apparent to those skilled in the art from this description and from practice of the invention. The scope is not intended to be limited to the particular forms disclosed and the invention covers all modifications, equivalents, and alternatives falling within the spirit and scope of the invention as defined by the claims.

As used herein, the articles including “the,” “a” and “an” when used in a claim or in the specification, are understood to mean one or more of what is claimed or described.

As used herein, the terms “include,” “includes” and “including” are meant to be non-limiting.

As used herein, the terms “active” and “agent” are used interchangeably.

As used herein, the term “renewable” (as in “renewable feedstock”) refers to materials (e.g., surfactant, solvent, acidifying agent) that are derived from a renewable feedstock and contain renewable carbon. The term “renewable” is used interchangeably with the terms “biobased” and “natural.” A renewable feedstock is a feedstock that is derived from a renewable resource, e.g., plants, and non-geologically derived. A material may be partially renewable (less than 100% renewable carbon content), 100% renewable (100% renewable carbon content), or somewhere in between (e.g., 50% renewable carbon content). A renewable material, for example a renewable ethanol, may be blended with a non-renewable material, for example, conventional ethanol, to yield a partially renewable material, e.g., partially renewable ethanol.

The terms “microorganism” or “microbe” as used herein are intended to include cellular organisms, both unicellular and multicellular that are less than 5 mm in length, and include but are not limited to bacteria, fungi, prions, enveloped and non-enveloped viruses, archaea, protists, protozoa or oocysts formed by protozoa, green algae, plankton, planarian, amoebas and yeasts, or spores formed by any of these. The terms “microorganism” or “microbe” include the single or planktonic microbes that may contaminate surfaces, as well as communities of microbes that grow as biofilms on surfaces.

The term “antimicrobial” as used herein refers to a compound that exhibits microbicide or microbiostatic properties that enables the compound to kill, destroy, inactivate, or neutralize a microorganism; or to mitigate, prevent, or reduce the growth, ability to survive, or propagation of a microorganism. In the context of antimicrobial, the term “treat” means to kill, destroy, inactivate, or neutralize a microorganism; or to prevent or reduce the growth, ability to survive, or propagation of a microorganism

The term “substantially free of” or “substantially free from” as used herein refers to either the complete absence of an ingredient or a minimal amount thereof merely as impurity or unintended byproduct of another ingredient. A composition that is “substantially free” of/from a component means that the composition comprises less than about 0.01%, or less than about 0.001%, or even 0%, by weight of the composition, of the component.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

All cited patents and other documents are, in relevant part, incorporated by reference as if fully restated herein. The citation of any patent or other document is not an admission that the cited patent or other document is prior art with respect to the present invention.

In this description, all concentrations and ratios are on a weight basis of the composition unless otherwise specified.

Unless otherwise noted, all component or composition levels are in reference to the active portion of that component or composition, and are exclusive of impurities, for example, residual solvents or by-products, which may be present in commercially available sources of such components or compositions.

All measurements are performed at 25° C. unless otherwise specified.

### Method

In the method of the invention the fabric is treated by contacting the fabric with an aqueous liquor comprising a surfactant; an acidifying agent; an amide of formula I:

R1-CO—NR2R3 (I)

wherein R1 is selected from the group consisting of linear or branched, substituted or unsubstituted C6-C12, each of R2 and R3 is independently selected from H, OH, a halogen, or C1-C6 linear or branched, substituted or unsubstituted hydrocarbyl groups; optionally an antimicrobial active; and water; wherein said composition has a pH from about 3.0 to about 6.5, preferably from 3.5 to 6.

Preferably the aqueous liquor is formed by adding to water a composition comprising the surfactant, acidifying agent, amide, optional antimicrobial active and water, along with further optional adjuncts.

The fabric is contacted with said aqueous liquor in a contacting step (also referred to herein as a treatment step), typically as part of a fabric laundering process. The contacting step may be a pre-treatment step prior to a washing/laundering step.

Preferably the contacting/treatment step comprises a post-washing step and the contacting step is a rinse step. For example, the method of the invention may comprise the steps of (i) in a laundering step, treating a fabric with an aqueous wash liquor; (ii) optionally rinsing the fabric one or two or more times with water; and (iii) in a contacting step, contacting the fabric with the fabric softener composition. Step (iii) is preferably a rinse step in a hand-washing or machine-washing fabric laundering process. Following the contacting step, the fabric is dried in a drying step (iv). A further additional rinse step may be provided between steps (iii) and (iv) however it may be preferred for the fabric to be dried immediately after step (iii).

In the washing/laundering step, generally, an effective amount of a detergent composition is added to water, for example in a conventional washing step, to form the aqueous wash liquor. The aqueous wash liquor so formed is then contacted, typically under agitation, with the fabrics to be laundered. The detergent composition typically comprises a surfactant system and optional cleaning adjuncts. The surfactant system preferably comprises anionic and/or nonionic surfactant.

An effective amount of the detergent composition added to water to form aqueous laundering solutions can comprise amounts sufficient to form from about 500 to 25,000 ppm, or from 500 to 15,000 ppm of composition in aqueous washing solution, or from about 1,000 to 3,000 ppm of the detergent compositions herein will be provided in aqueous washing solution.

Typically, the wash liquor is formed by contacting the detergent with wash water in such an amount so that the concentration of the detergent in the wash liquor is from 0.1 g/l to 5 g/l, or from 1 g/l, and to 4.5 g/l, or to 4.0 g/l, or to 3.5 g/l, or to 3.0 g/l, or to 2.5 g/l, or even to 2.0 g/l, or even to 1.5 g/l.

The wash liquor may comprise 40 litres or less of water, or 30 litres or less, or 20 litres or less, or 10 litres or less, or 8 litres or less, or even 6 litres or less of water. Typically, from 0.01 kg to 2 kg of fabric per litre of wash liquor is dosed into said wash liquor. Typically, the wash liquor comprising the detergent of the invention has a pH of from 3 to 11.5, typically from 7 to 10.

The laundering step may be followed by one or more optional rinsing steps.

In the treatment step (iii), the fabric is treated with the aqueous liquor, preferably either in a hand washing or in a laundry washing machine rinse step. This step is preferably the final rinse step, immediately before drying the fabric. If desired a rinse step may take place between the rinse-treatment step and drying the fabric. If desired a fabric softener composition may be added in a rinse step prior to the contacting step herein, or following the contacting step herein.

Drying of the fabric may be by any conventional means either in domestic or industrial settings: machine drying or open-air drying. The fabric may comprise any fabric capable of being laundered in normal consumer or institutional use conditions, and the invention is suitable for synthetic textiles such as polyester and nylon and natural fabrics comprising cellulosic fabrics and mixed fabrics comprising synthetic and natural fibres, such as polycotton. The water temperature in the contacting step is typically in the range from about 5° C. to about 90° C., though lower water temperatures up to 60 or 40 or 30° C. are useful. The water to fabric ratio is typically from about 1:1 to about 30:1.

Alternatively, the contacting step may be by application of the aqueous liquor directly to the fabric for example by spraying. Ready to use compositions may provide more convenience to the user.

The contacting step may be from about 10 seconds to about 15 minutes or from about 15 seconds to about 10 minutes, or from 30 seconds to about 5 or 2 or 1 minute.

The method of the present invention may deliver cleaning benefits. The method of the present invention may deliver improved antimicrobial activity in the aqueous liquor and/or on the treated fabric.

### Surfactant

The compositions for use in the method of the present disclosure may comprise one or more surfactants. The surfactant may comprise from about 6 to about 12 carbon atoms, or from about 6 to about 11 carbon atoms, or from about 6 to about 10 carbon atoms, or from about 8 to about 10 carbon atoms. The surfactant may be branched or linear, saturated or unsaturated. The surfactant may be branched and comprise from about 6 to about 12 carbon atoms, or from about 6 to about 11 carbon atoms, or from about 6 to about 10 carbon atoms, or from about 8 to about 10 carbon atoms in the primary carbon chain, where “primary carbon chain” denotes the longest carbon-based chain that is uninterrupted by a heteroatom, such as O, S, N and P. For example, n-octyl sulfate has 8 carbon atoms in the primary carbon chain, 2 propyl-1-heptyl sulfate has 7 carbon atoms in the primary carbon chain, and dodecyl methyl ester sulfonate (C₁₀H₂₁—CH(SO₃⁻)—C(O)O—CH₃) has 11 carbon atoms in the primary carbon chain. In the context of branched surfactants, Cₙ (such as C₁ or C₈) refers to the number of carbon atoms in the primary carbon chain (for example, a 2-ethyl-1-hexyl primary carbon chain is C₆). In the context of linear (or unbranched) surfactants, Cₙ (such as C₁ or C₈) refers to the total number of carbon atoms in the surfactant.

The surfactants may be substantially free of trace transition metal impurities (particularly for antimicrobial compositions comprising hydrogen peroxide). The surfactants may be substantially free of trace levels of chloride, bromide, and iodide (particularly for antimicrobial compositions comprising ionic silver).

The compositions may comprise from about 0.01% to about 60%, or from about 0.01% to about 40%, or from about 0.03% to about 35%, or from about 0.05% to about 30% of surfactant.

The compositions disclosed herein are generally intended to be diluted prior to use, for example by addition to water in a rinse step of a washing process. A composition may comprise from about 0.5% to about 1%, or from about 1% to about 2%, or from about 2% to about 3%, or from about 3% to about 5%, or from about 5% to about 10%, or from about 10% to about 20%, or from about 20% to about 40%, of surfactant.

Without being bound by theory, it is believed that the short chain-length of the surfactant—from about 6 to about 12 carbon atoms, or from about 6 to about 11 carbon atoms, or from about 6 to about 10 carbon atoms, or from about 8 to about 10 carbon atoms—may, in addition to the usual properties provided by surfactants be particularly beneficial for antimicrobial applications involving shorter contact times between the microorganism and the composition, for example, from about 10 seconds to about 3 minutes or from about 15 seconds to about 2 minutes, or from 30 seconds to about 1 minute. The short chain-length of the surfactant is believed to enhance the activity of antimicrobial active(s) in the composition. The short chain-length of the surfactant is also believed to help solubilize the (otherwise substantially water-insoluble) amide. Critical Micelle Concentration (CMC) measurements in the presence and absence of the amide indicate that the surfactants disclosed herein enhance the solubility of the amide by incorporating the amide into the micellar structure(s) of the surfactant. The CMC of the surfactant is significantly reduced, and this provides a reservoir of solubilized amide for antimicrobial potentiation activity. It is believed that the chain-length of the surfactant and the chain-length of the amide may be matched, for example, where the difference between the chain-length of the surfactant and the chain-length of the amide is about 2 to about 3 carbon atoms, to provide a combination of increased solubility of the amide in the composition and increased antimicrobial activity of the composition.

The compositions disclosed herein may comprise one or more C₁₃₋₁₈ surfactants. For example, commercial surfactants are generally made up of a blend of molecules having different alkyl chain lengths (though it is possible to obtain single chain-length cuts), e.g., Polystep® B-25 (from the Stepan Company) is described as sodium decyl sulfate but also contains about 25%-30% dodecyl sulfate, by weight of the alkyl sulfate surfactant. Similarly, many commercial lauryl surfactants may include about 30% or more surfactant having chain-length(s) greater than C₁₂. When C₁₃₋₁₈ surfactant is present in the composition(s), the weight ratio of C₆₋₁₂ surfactant to C₁₃₋₁₈ surfactant may be greater than about 2:1, or greater than about 3:1. The average chain-length of the surfactant in the composition(s) may be less than about C₁₂, or less than about C₁₁. The surfactant in the composition may have an average chain-length of from about C₇ to about C₈, or from about C₈ to about C₉, or from about C₉ to about C₁₀, or from about C₁₀ to about C₁₁. The composition(s) may comprise surfactant having an average chain-length of about C₈.

The solubility of the amide may be further increased by utilizing C₁₃₋₁₈ surfactants. However, increased surfactant chain-length further reduces CMC, which means that a reduced concentration of both surfactant monomer and amide monomer is available for antimicrobial potentiation. Thus, there may be an optimal balance of shorter chain-length surfactant and longer chain-length surfactant, whereby the longer chain-length surfactant helps to solubilize the amide via formation of mixed micelles, and the shorter chain-length surfactant increases the CMC of the surfactant and the concentration of surfactant monomers and amide monomers that drive short-contact-time antimicrobial activity. The optimal balance may vary, depending on whether short-contact-time antimicrobial activity is desired. In other words, increased CMC values may be advantageous for faster activity, while reduced CMC values may be advantageous for longer-contact-time applications.

The compositions useful in the contacting step of the invention herein may comprise a surfactant comprising from about 6 to about 12 carbon atoms and an amide of formula I (comprising from about 6 to about 12 carbon atoms). The CMC of the composition may be from about 100 ppm to about 2,500 ppm, or from about 200 ppm to about 2,000 ppm, or from about 300 ppm to about 1,500 ppm.

The composition(s) disclosed herein may comprise surfactant selected from the group consisting of an anionic surfactant, a cationic surfactant, a nonionic surfactant, an amphoteric surfactant, a zwitterionic surfactant, and mixtures thereof.

Suitable anionic surfactants include the sodium, potassium, ammonium, alkanol-ammonium magnesium and calcium salts of C₈-C₁₀ glyceryl ether sulfonates, C₈ alkyl sulfonates, C₂-C₈ linear alkyl benzene sulfonate, C₆-C₁₂ alkyl sulfates, C₈-C₁₂ alkyl ether sulfates, C₅₋₁₀ alkyl and alkenyl succinates as mono or dianionic surfactants [e.g., R—CH(COO⁻M⁺)—CH₂—COO⁻M⁺, R—CH(COO⁻M⁺)—CH₂—COOH⁻ and R—CH(COOH)—CH₂—COO⁻M⁺ wherein R═C₅₋₁₀ linear or branched alkyl or alkenyl group and M=lithium, sodium, potassium, ammonium or alkanol-ammonium, and mixtures thereof], C₈-C₁₂ methyl ester sulfonates, C₈-C₁₂ fatty acid sulfonates and C₆-C₁₂ carboxylates, and mixtures thereof. The surfactant may comprise an anionic surfactant selected from the group consisting of sodium octyl sulfate, sodium decyl sulfate, sodium octyl glyceryl ether sulfonate (C₈H₁₇—O—CH₂—CH(OH)—CH₂SO₃Na), the sodium salt of 2-propyl-1-heptyl sulfate, the sodium salts of C₉₋₁₁ secondary sulfates, the sodium salts of C₁₂ methyl ester sulfonate and C₁₂ fatty acid sulfonate, and mixtures thereof. The surfactant may comprise an anionic surfactant selected from the group consisting of octyl sulfate, sodium decyl sulfate, and mixtures thereof. The anionic surfactant may be derived from a renewable feedstock, for example, n-octyl alcohol or n-decyl alcohol derived from plant oils for the making of n-octyl sulfate and n-decyl sulfate, respectively, and n-dodecyl methyl ester derived from plant oils for the making of C₁₂ methyl ester sulfonate and C₁₂ fatty acid sulfonate.

Suitable nonionic surfactants include linear or branched, saturated or unsaturated alcohol alkoxylates, alkyl glycosides, and alkyl ethoxy carboxylic acids comprising from about 6 to about 12 carbon atoms in the primary chain. The surfactant may comprise a nonionic surfactant selected from the group consisting of C₆₋₁₂ alcohol ethoxylate comprising an average of from about 1 mole to about 7 moles of ethylene oxide, C₆₋₁₂ alcohol ethoxy propoxylate comprising an average of from about 1 mole to about 7 moles of ethylene oxide and from about 1 mole to about 4 moles of propylene oxide, C₈ pyrrolidone, C₈ and C₈₋₁₀ alkyl polyglucoside with a degree of glucoside polymerization of from about 1 to about 1.6, C₈₋₁₀ alkyl polypentoside (e.g., xyloside and riboside) with a degree of sugar pentoside polymerization of from about 1 to about 1.6, and C₁₂ ethoxy carboxylic acid comprising an average of from about 1 mole to about 3 moles of ethylene oxide.

The surfactant may comprise a nonionic surfactant selected from the group consisting of octyl alkylpolyglycoside, decyl alkylpolyglycoside, octyl pyrrolidone, and mixtures thereof. As in the case of the anionic surfactant, the nonionic surfactant may be derived from a renewable feedstock. For example, the C₈ and C₈₋₁₀ alkyl polyglycosides (hexosides and pentosides) may be made from entirely renewable feedstocks.

Suitable cationic surfactants include saturated or unsaturated betaines, amine oxides, alkyl morpholinium compounds and alkyl trimethyl ammonium compounds comprising from about 6 to about 12 carbon atoms. The surfactant may comprise a cationic surfactant selected from the group consisting of n-octyl dimethyl amine oxide, n-octyl dimethyl betaine, n-octyl amidopropyl betaine, and mixtures thereof. The cationic surfactant may be derived from a renewable feedstock.

Suitable zwitterionic surfactants include 2-ethyl-1-hexyl imino dipropionate as well as n-dodecyl imino dipropionate (mono- and dianionic salts), C₆₋₁₂ amphoglycinates, and C₆₋₁₂ alkyl sulfobetaines, such as the sodium salt of n-octyl, n-decyl, or n-dodecyl N,N-dimethyl-3-ammonio-1-propanesulfonate.

The composition(s) disclosed herein may comprise surfactant selected from the group consisting of C₈ glyceryl ether sulfonate, C₆-C₁₂ alkyl sulfate, C₈-C₁₂ methyl ester sulfonate, C₈-C₁₂ fatty acid sulfonate, C₆-C₁₂ ether carboxylate, C₈₋₁₀ amine dimethyl oxide, C₈ pyrrolidone, C₈ dimethyl betaine, C₈₋₁₀ alkyl polyglycoside, C₈₋₁₂ N,N-dimethyl-3-ammonio-1-propanesulfonate, and mixtures thereof. The antimicrobial composition(s) disclosed herein may comprise from about 0.05% to about 30% of surfactant, where the surfactant is selected from the group consisting of sodium octyl sulfate, sodium decyl sulfate, sodium octyl glyceryl ether sulfonate, sodium dodecyl methyl ester sulfonate, sodium dodecyl fatty acid sulfonate, octyl dimethyl amine oxide, octyl pyrrolidone, and mixtures thereof.

### Acidifying Agent

The acidifying agent may adjust the pH of the aqueous liquor to the range from about 3 to about 96.5 or from 3.5 to 6. Preferably the aqueous liquor is formed by addition of the compositions disclosed herein to water. The acidifying agent may adjust the pH of the compositions in the following range: from about 1.0 to about 6.0, or from about 1.0 to about 5.5, or from about 1.0 to about 5.0, or from about 2.5 to about 5.0. The acidifying agent may help stabilize the pH of the composition by providing buffering capacity. The acidifying agent may also sequester transition metals, including iron, copper, manganese and the like. The acidifying agent may be chosen to further enhance the antimicrobial activity of the composition. The acidifying agent may be a US EPA/Health Canada registered active or a European notified antimicrobial substance.

The acidifying agent may comprise an organic acid, an inorganic acid, or a mixture thereof. The acidifying agent may be substantially free of trace transition metal impurities. Suitable inorganic acids include phosphoric acid, sulfuric acid, urea-sulfuric acid, hydrochloric acid, sulfamic acid, methyl sulfuric acid, hypochlorous acid, sodium bisulfate, and the like. Suitable organic acids include polymeric acids comprising at least 3 carboxylic acid groups, C₁-C₁₁ organic acids comprising at least one carboxylic acid group, and organic acids that do not comprise carboxylic acid functional groups (such as imidazole derivatives or phenolic or polyphenolic compounds). Non-limiting examples of polymeric acids include polymers of acrylic acid, methacrylic acid, maleic acid, or itaconic acid or copolymers of acrylic acid, methacrylic acid, maleic acid, itaconic acid, or mixtures thereof. Polymeric acids may be homopolymers or copolymers having a molecular weight of about 500 g/mol or greater. The polymeric acid may have a molecular weight ranging from about 500 g/mol to about 1,000,000 g/mol, or from about 500 g/mol to about 100,000 g/mol, or from about 1,000 g/mol to about 20,000 g/mol. Copolymers may be random copolymers or block copolymers. In addition to monomer units comprising carboxylic acid groups, the copolymers may also include one or more other monomers, such as styrene, acrylic ester, acrylamide, olefin sulfonate, and olefin acetate.

Non-limiting examples of C₁-C₁₁ organic acids include formic acid, acetic acid, benzoic acid, malonic acid, citric acid, maleic acid, fumaric acid, succinic acid, lactic acid, malic acid, tartaric acid, gluconic acid, glutaric acid, adipic acid, 2-ethyl-1-hexanoic acid, heptanoic acid, octanoic acid, nonanoic acid, undecylenic acid, butane tetracarboxylic acid, and the like. The organic acid may be derived from a renewable, plant-based feedstock and produced using natural processes, such as fermentation; examples include bio-based acetic acid, bio-based citric acid, bio-based lactic acid and bio-based succinic acid, and the like. The organic acid may have food-use pedigree or be Generally Regarded As Safe (GRAS) or a food additive by the US Food & Drug Administration.

The composition(s) disclosed herein may comprise acidifying agent, where the acidifying agent is selected from the group consisting of formic acid, acetic acid, benzoic acid, malonic acid, citric acid, maleic acid, fumaric acid, hypochlorous acid, succinic acid, gluconic acid, glutaric acid, lactic acid, 2-ethyl-1-hexanoic acid, octanoic acid, nonanoic acid, peracetic acid, peroctanoic acid, undecylenic acid, and mixtures thereof, or the acidifying agent is selected from the group consisting of benzoic acid, citric acid, lactic acid succinic acid, maleic acid, succinic acid, octanoic acid, and mixtures thereof.

The compositions may comprise from about 0.01% to about 40%, or from about 0.03% to about 25%, or from about 0.05% to about 10% acidifying agent. A concentrated composition may comprise from about 0.5% to about 1%, or from about 1% to about 3%, or from about 3% to about 5%, or from about 5% to about 10%, or from about 10% to about 20%, or from about 20% to about 40% of acidifying agent. An increased concentration of acidifying agent increases the composition's reserve buffering capacity, which reduces pH fluctuation upon dilution. Partial neutralization of the acidifying agent to a pH value just below its pKa (e.g., 0.1 to 0.5 pH units below the acidifying agent's pKa) may also help to reduce pH fluctuation upon dilution.

Generally, an increased pH may improve the overall safety of the composition, enhance the compatibility of the composition with a larger variety of optional adjuncts, and increase the scope of applications for which the composition may be used. For compositions having pH 3.5 or greater, the acidifying agent may be selected from acidifying agents having pKa values greater than about 4.0; non-limiting examples of such acidifying agents include acetic acid (pKa=4.8), succinic acid (pKa 4.2), benzoic acid (pKa=4.2), trans-cinnmaic acid (pKa=4.4), p-coumaric acid (4-hydroxy cibnnamic acid, pKa=4.6), octanoic acid (pKa 4.9), undecylenic acid (pKa 5.0), heptanoic acid (pKa=5.1), nonanoic acid (pKa=5.2), imidazole (pKa=7.0), hypochlorous acid (pKa=7.0) and mixtures thereof. Diprotic acid salts, such as the monosodium salt of maleic acid (pKa2=6.1), and triprotic acid salts, such as the mono- and dibasic salts of citric acid (pKa2=4.5, pKa3=6.4), may also be used to adjust the pH of the composition to pH 4.0 and greater.

The weight ratio of surfactant to acidifying agent in the composition may be from about 50:1 to about 1:50, or from about 10:1 to about 1:10, or from about 5:1 to about 1:5, or from about 3:1 to about 1:3.

The acidifying agent may be chosen to potentiate or provide antimicrobial properties. The acidifying agent may be selected from the group consisting of benzoic acid, citric acid, succinic acid, glycolic acid, lactic acid, octanoic acid, hypochlorous acid, peroxyacetic acid, peroxyoctanoic acid, and mixtures thereof. Acids characterized by reduced water solubility, including succinic acid, benzoic acid, cinnamic acid and octanoic acid, may be especially beneficial.

### Amide

The compositions disclosed herein may comprise an amide of formula I,

R¹—CO—NR²R³ (I)

where R¹ is selected from the group consisting of linear or branched, substituted or unsubstituted C₆-C₁₂, or C₆-C₁₀ hydrocarbyl groups, each of R² and R³ is independently selected from H, OH, a halogen, or C₁-C₆ linear or branched, substituted or unsubstituted hydrocarbyl groups.

The compositions disclosed herein may comprise from about 0.01%, or from about 0.03%, or from about 0.05% to about 15%, or to about 25%, or to about 40% by weight of an amide of formula I.

A composition may comprise from about 1% to about 40%, or from about 1% to about 25%, or from about 1% to about 15%, or from about 1% to about 8%, or from about 1% to about 5%, or from about 1% to about 3% by weight of an amide of formula I. A concentrated antimicrobial composition may comprise from about 3% to about 40%, or from about 3% to about 15%, from about 3% to about 8%, from about 3% to about 5% by weight of an amide of formula I. An antimicrobial composition may comprise from about 5% to about 40%, or from about 5% to about 15%, or from about 5% to about 8% by weight of an amide of formula I. A concentrated composition may comprise from about 8% to about 40%, or from about 8% to about 15% by weight of an amide of formula I. A composition may comprise from about 15% to about 40% by weight of an amide of formula I. The weight ratio of surfactant to amide of formula I may be from about 0.05:1 to about 10:1, or from about 0.1:1 to about 5:1, or from about 0.2:1 to about 5:1, or from about 0.25:1 to about 5:1.

The composition(s) disclosed herein may comprise surfactant, which comprises from about 6 to about 12 carbon atoms, and an amide of formula I, where the weight ratio of the surfactant to the amide of formula I is from about 0.25:1 to about 5:1.

Amides of formula I include monounsaturated amides, saturated amides, and hydroxamic acids. Non-limiting examples of amides of formula I include n-octanamide, N-hexyl-N-methyl decanamide, N,N-diethanol octanamide, N,N-dibutyl hexanamide, octanohydroxamic acid, and N,N-diethanol dodecanamide. The composition(s) disclosed herein may comprise amide of formula I, wherein the amide of formula I is selected from the group consisting of N,N-dimethyl octanamide, N,N-dimethyl decanamide, N,N-dimethyl 9-decenamide, N.N-dimethyl 7-octenamide, octanohydroxamic acid, and mixtures thereof. It is noted that C₆₋₁₂ hydroxamic acids, such as octanohydroxamic, may also provide chelation. For example, octanohydroxamic acid is known to have transition metal chelation properties, especially with respect to iron cations. As such, octanohydroxamic acid may be used, as a chelator, in combination with another amide of formula I, to supplement the activity of other amide. Combinations of C₆₋₁₂ hydroxamic acid or C₆₋₁₀ hydroxamic acid and another amide of formula I may be beneficial in promoting enhanced antimicrobial activity. Commercially available amides of formula I include Genagen 4296®, an N,N-dimethyl decanamide available from Clariant, Steposol® MET 10U, a N,N-dimethyl 9-decenamide available from Stepan Company, Cola®Mid AL, a lauric acid N,N-diethanol amide available from Colonial Chemical, and octanohydroxamic acid available from TCI America. Additionally, Steposol® M-8-10 is a mixture comprising approximately 55-60% N,N-dimethyl octanamide and approximately 40-45% N,N-dimethyl decanamide, which is derived from coconut oil and available from the Stepan Company.

It is believed that the amides disclosed herein potentiate the activity of antimicrobial actives against a variety of microorganisms, including Gram-positive bacteria, Gram-negative bacteria, non-enveloped viruses, fungi, mycobacteria, and even spore-forming organisms, such as Clostridium difficile spores. These potentiating effects are surprising given that amides alone are not known to have strong antimicrobial activity. Without wishing to be bound by theory, it is believed that the lipophilic character of the amide contributes to these potentiating effects; the amide is believed to preferentially partition into the microorganism, versus remaining in its monomer form in the composition. This partitioning is believed to induce micelles in the composition to release more amide monomers, in order to re-establish thermodynamic equilibrium. The released amide monomers again preferentially partition into the microorganism and the whole series of events—where amide monomers are continuously created from micelles and are then used up against the target microorganism—may contribute to the rapid antimicrobial activity of the disclosed compositions. By quickly and continuously permeating though microorganism defenses, the amide compound may also potentiate the activity of antimicrobial actives that are present in the composition.

For example, a composition that comprises hydrogen peroxide, as an antimicrobial active, may exhibit enhanced Fenton chemistry, with iron or copper from the microorganism, and may generate increased concentrations of oxygen-based radicals, which may react with the amide to form peracids or other highly reactive oxygen species (particularly, but not necessarily, inside the microorganism). For a composition comprising ionic silver, as an antimicrobial active, the nitrogen atom of the amide may associate with ionic silver, via a Lewis acid-base interaction, and may help to transport the silver ion into a microorganism, where it may cause death via known mechanisms.

The amide(s) disclosed herein may hydrolyze, over time, to its corresponding fatty acid, due to the acidic pH of the composition, particularly at a pH ranging from about 1 to about 2.5, and/or at increased temperatures (e.g., above room temperature). The compositions disclosed herein may therefore comprise a mixture of amide and its corresponding fatty acid. The fatty acid formed via hydrolysis may also contribute to antimicrobial activity, especially for compositions comprising hydrogen peroxide. For compositions comprising the amide of formula I and hydrogen peroxide, peracids may be formed via the following reactions:

R¹—C(O)N(R²)(R³)+H₂O═R¹C(O)OH+NH(R²)(R³); and

R—C(O)OH+H₂O₂═R—C(O)OOH+H₂O.

As amide hydrolysis is catalyzed by acid, increasing the pH of the composition may reduce amide hydrolysis, thereby reducing the concentration of peracid.

The level of fatty acid formed by amide hydrolysis may optionally be adjusted by the addition of from about 0.1% to about 10% of a lower alcohol, a primary C₁-C₆ amine, a secondary C₁-C₆ amine, a C₁-C₆ alkanol amine, or a mixture thereof to the composition. Suitable lower alcohols include methanol, ethanol, propylene glycol, dipropylene glycol, diethyleneglycol, glycerol, diglycerol, polyglycerol, or C₁ to C₈ mono- or di-glycerol ethers. The compositions disclosed herein may further comprise an ester. The compositions disclosed herein may comprise a mixture of amide(s), fatty acid(s) (e.g., generated via hydrolysis of the amide), and ester(s). Esters typically have desirable odor profiles.

### Water

The compositions disclosed herein may comprise water. The water may be of any hardness. The water may be de-ionized water, reverse-osmosis-treated water, distilled water, or soft water (typically, soft water does not exceed 40 ppm hardness (as CaCO₃)). The water may be de-ionized and/or reverse osmosis treated and may comprise less than about 1 ppm transition metal ion, or less than about 100 ppb transition metal ion.

The compositions may comprise from about 15% to about 99.95%, or from about 20% to about 95%, or from about 20% to about 90%, or from about 25% to about 85% water by weight of the composition. The amount of water in a given composition depends on the degree to which the composition is concentrated. A super concentrate composition may comprise less than about 50%, or from about 15% to about 40%, or from about 20% to 35% of water by weight of the composition. Such super concentrates may provide improved economics on a per-use basis (e.g., following recommended dilution) for the user. Also, the water activity of a super concentrate may be sufficiently reduced, such that the composition does not freeze at temperatures as low as −3° C., or as low as −18° C. Super concentrates may also exhibit improved ambient-temperature (e.g., 20-23° C.) phase stability. Compositions comprising increased water content may also freeze more readily and exhibit phase instability upon thawing (e.g., crystallization or precipitation of one or more components). Super concentrate compositions may comprise surfactant, for example, a surfactant comprising from about 10 to about 12 carbon atoms; the surfactant may improve the ambient-temperature phase stability of the super concentrate compositions, upon dilution with water.

The aqueous liquor may comprise from about 70% to about 99.9%, or from about 75% to about 99.5% water, or from about 80% to about 99% water.

The composition(s) disclosed herein may comprise from about 0.01% to about 60%, or from about 0.01% to about 40% of surfactant, from about 0.01% to about 40% of acidifying agent, from about 0.01% to about 40% of amide of formula I, and from about 15% to about 99.95% of said water.

pH

The compositions disclosed herein may have pHs ranging from about 1.0 to about 6.0, or from about 1.0 to about 5.5, or from about 1.0 to about 5.0, or from about 2.5 to about 6.0, or from about 2.5 to about 5.5, or from about 2.5 to about 5.0, or from about 4.0 to about 5.5. For a concentrated composition that comprises less than about 70% water, the pH is measured after adding de-ionized water to the composition, until the total concentration of water in the composition is about 70%. For compositions that comprise greater than or equal to about 70% water, pH is measured on the composition as made (the composition is not diluted prior to measuring the pH).

The composition(s) disclosed herein may comprise surfactant; acidifying agent; amide of formula I:

R¹—CO—NR²R³ (I)

where R¹ is selected from the group consisting of linear or branched, substituted or unsubstituted C₆-C_{12,} or C₆-C₁₀ hydrocarbyl groups, each of R² and R³ is independently selected from H, OH, a halogen, or C₁-C₆ linear or branched, substituted or unsubstituted hydrocarbyl groups; and water; where said composition has a pH from about 1.0 to about 6.0.

### Antimicrobial Active

The compositions herein may comprise an antimicrobial active. The antimicrobial active is a material recognized by a governmental agency to provide antimicrobial activity. The antimicrobial active may be selected from the group consisting of benzoic acid, citric acid, glycolic acid, lactic acid, octanoic acid, nonanoic acid, decanoic acid, hypochlorous acid, hydrogen peroxide, peroxyacetic acid, peroxyoctanoic acid, ionic silver compounds, and mixtures thereof. The compositions disclosed herein may also optionally comprise from about 0.1% to about 10%, or from about 0.1% to about 5%, or from about 0.1% to about 1%, of a cationic antimicrobial agent. Suitable cationic antimicrobial agents for use in the compositions disclosed herein include benzalkonium chloride, benzethonium chloride, chlorhexidine diacetate, polyhexamethylene biguanide (PHMB), chlorhexidine digluconate, and mixtures thereof. The compositions may also comprise an antimicrobial agent selected from the group consisting of glutaraldehyde, zinc 2-pyridinethiol-1-oxide, copper sulfate pentahydrate, iodine, iodine salts, butoxypolypropoxypolyethoxyethanol iodine complex, polyvinylpyrrolidone-iodine complex, and mixtures thereof.

The antimicrobial active may be selected from the group consisting of ionic silver, an active oxygen source, such as hydrogen peroxide, and mixtures thereof.

As used herein, “ionic silver,” refers to any silver (I) compound that may be solubilized or dispersed in an aqueous medium at a pH ranging from about 1.0 to about 6.0. Examples of ionic silver include silver acetate, silver lactate, silver nitrate, silver dihydrogen citrate, silver sulfate, silver citrate, as well as complexes of silver I formed with ammonia. The composition may comprise from about 0.001%, or from about 0.002%, or from about 0.003%, or from about 0.005% to about 0.25%, or to about 0.3%, or to about 0.5%, or to about 2% of ionic silver by weight of the composition.

The concentration of ionic silver is calculated as the weight percent of silver present in an ionic silver compound. For example, the weight percent of ionic silver in a composition comprising 0.1% silver nitrate is 0.064% [0.1%*(107.9/169.9)] and the weight percent of silver in a composition comprising 0.1% silver dihydrogen citrate is 0.036% [0.1%*107.9/300.0]. The concentration of ionic silver in the composition depends on the desired concentration of the overall composition (e.g., concentrate versus ready-to-use) as well as the antimicrobial benefits sought. Compositions comprising ionic silver may be substantially free of chloride ion, iodide ion, and/or bromide ion impurities; the compositions may comprise less than about 10 ppm chloride ion, less than about 10 ppm iodide ion, less than about 10 ppm bromide ion, or less than about 10 ppm of a mixture thereof, or less than about 1 ppm chloride ion, less than about 1 ppm iodide ion, less than about 1 ppm bromide ion, or less than about 1 ppm of a mixture thereof.

The composition may comprise from about 0.01%, or from about 0.03%, or from about 0.05%, or from about 0.06%, or from about 0.07% to about 8%, or to about 10%, or to about 15%, or to about 20%, or to about 30% hydrogen peroxide. The composition may comprise from about 0.01%, or from about 0.03%, or from about 0.05%, or from about 0.06%, or from about 0.07% to about 8%, or to about 10%, or to about 15%, or to about 20%, or to about 30% of hydrogen peroxide by weight of the composition. The concentration of hydrogen peroxide in the composition depends on the desired concentration of the overall composition (e.g., concentrate versus ready-to-use) as well as on the antimicrobial benefits sought.

Compositions comprising hydrogen peroxide may comprise less than about 5 ppm transition metal ion impurities, or less than about 2 ppm transition metal ion impurities, or less than 0.5 ppm transition metal ion impurities. Compositions comprising hydrogen peroxide may comprise less than about 5 ppm ferrous ion, less than about 5 ppm ferric ion, or less than about 5 ppm of a mixture thereof, or less than about 1 ppm ferrous ion, less than about 1 ppm ferric ion, or less than about 1 ppm of a mixture thereof, or less than about 0.1 ppm ferrous ion, less than about 0.1 ppm ferric ion, or less than about 0.1 ppm of a mixture thereof.

The concentration of hydrogen peroxide may be from about 1% to about 30%, or from about 1% to about 15%, or from about 1% to about 8%, or from about 1% to about 5%, or from about 1% to about 3%, or from about 3% to about 30%, or from about 3% to about 15%, or from about 3% to about 8%, or from about 3% to about 5%, or from about 5% to about 30%, or from about 5% to about 15%, or from about 5% to about 8%, or from about 8% to about 30%, or from about 8% to about 15%, or from about 15% to about 30% by weight of the composition.

The concentration of hydrogen peroxide may be from about 0.01% to about 8.0%. The weight ratio of hydrogen peroxide to acidifying agent is from about 0.1:1 to about 10:1, or from about 0.2:1 to about 5:1, or from about 0.5:1 to about 2:1. The composition(s) disclosed herein may comprise acidifying agent and an antimicrobial active, where the antimicrobial active comprises hydrogen peroxide, where the weight ratio of the acidifying agent to the hydrogen peroxide is from about 0.2:1 to about 5:1.

The composition(s) disclosed herein may comprise from about 0.05% to about 8% of antimicrobial active, where the antimicrobial active comprises hydrogen peroxide. The composition(s) disclosed herein may comprise from about 0.002% to about 0.5% of antimicrobial active, where the antimicrobial active comprises ionic silver. The composition(s) disclosed herein may comprise from about 0.002% to about 0.5% of antimicrobial active, where the antimicrobial active comprises ionic silver selected from the group consisting of silver nitrate, silver dihydrogen citrate, silver acetate, silver sulfate, and mixtures thereof. The composition(s) disclosed herein may comprise amide of formula I and antimicrobial active, where the antimicrobial active comprises hydrogen peroxide, and in the amide of formula I, R¹ is selected from the group consisting of linear or branched, substituted or unsubstituted C₆-C₁₀ hydrocarbyl groups, wherein the weight ratio of hydrogen peroxide to the amide of formula I is from about 0.2:1 to about 5:1.

The combination of acid and hydrogen peroxide may generate measurable concentrations of peracid, from the reaction of acid and hydrogen peroxide.

The compositions disclosed herein may, however, comprise hydrogen peroxide and be substantially free of C₆₋₁₂ peracids. The compositions disclosed herein may comprise catalytic amounts of peracid; in other words, the compositions disclosed herein may comprise from about 1 ppm to about 50 ppm, or about 1 ppm to about 10 ppm peracid, e.g., C₆₋₁₂ peracid.

The compositions disclosed herein may comprise hydrogen peroxide and peracid, where the peracid is formed in-situ via the reaction of a carboxylic acid-containing acidifying agent and hydrogen peroxide. For example, when the composition comprises octanoic acid or nonanoic acid, as the acidifying agent, there may be peroxyoctanoic acid or peroxynonanoic acid, respectively, formed in-situ in the composition. The rate of formation of the peracid may depend on the pH of the composition (reduced pHs favor peracid formation and faster rates of formation). The compositions disclosed herein may comprise hydrogen peroxide and peracid, where the peracid is formed in-situ via the reaction of the fatty-acid-product of amide hydrolysis and hydrogen peroxide. Peracid species may have various benefits, including antimicrobial benefits.

The compositions may comprise C₆₋₁₂ fatty acid, or C₆₋₁₀ fatty acid, or C₈ fatty acid (octanoic acid). The weight ratio of the fatty acid to the amide of formula I may be from about 0.01:1 to about 1:1, or from about 0.05:1 to about 0.5:1. The weight ratio of fatty acid to the corresponding peracid may be from about 5:1 to about 1000:1, or from about 10:1 to about 500:1, or from about 15:1 to about 100:1. The compositions may comprise a combination of C₆₋₁₂ peracid and a short-chain peracid (e.g., peracetic acid and peroctanoic acid).

The composition(s) disclosed herein may comprise amide of formula I, antimicrobial active, where the antimicrobial active comprises hydrogen peroxide, and C₆₋₁₀ fatty acid, where the weight ratio of the C₆₋₁₀ fatty acid to the amide of formula I is from about 0.05:1 to about 0.5:1.

The composition may further comprise one or more esters of formic acid, acetic acid, benzoic acid, lactic acid, succinic acid, 3-hydroxybutyric acid and citric acid, such as isobutyl formate, butyl acetate, ethyl benzoate, ethyl lactate, butyl 3-hydroxybutyrate, or triethyl citrate. The compositions may further comprise peracid from the in-situ reaction of acidifying agent with hydrogen peroxide, or peracid formed by hydrolysis/perhydrolysis of amides and esters in the composition; alternatively, the compositions may be substantially free of peracid, especially peracid formed from amide precursors of formula I.

The concentration of in-situ generated C₆₋₁₂ peracid in the composition may be from about 0 ppm, or from about 0.5 ppm, or from about 1 ppm, to about 10 ppm, or to about 15 ppm, or to about 25 ppm, or to about 50 ppm. Surprisingly, the disclosed combination of surfactant, acidifying agent, and hydrogen peroxide, either in the absence of in-situ generated C₆₋₁₂ peracid or in combination with a low concentration of in-situ generated C₆₋₁₂ peracid, provides bactericidal activity at short exposure times (e.g., 15 seconds to 2 minutes). This surprising effect is demonstrated in the examples (compositions #15 and #16). The composition(s) disclosed herein may comprise an antimicrobial active, where the antimicrobial active comprises hydrogen peroxide, and from 1 to about 50 ppm of C₆₋₁₀ fatty peracid. The composition(s) disclosed herein may comprise an antimicrobial active, where the antimicrobial active comprises hydrogen peroxide, and from about 1 to about 25 ppm peroctanoic acid.

When the optional antimicrobial active is present, the weight ratio of the surfactant to the antimicrobial active may be from about 0.01:1 to about 300:1, or from about 0.1:1 to about 100:1, or from about 0.2:1 to 50:1. For compositions comprising ionic silver, as the optional antimicrobial active, the weight ratio of surfactant to ionic silver may be from about 1:1 to about 300:1, or from about 2:1 to about 200:1, or from about 4:1 to about 150:1, or from about 10:1 to about 100:1. For compositions comprising hydrogen peroxide, as the optional antimicrobial active, the weight ratio of surfactant to hydrogen peroxide may be from about 0.05:1 to about 20:1, or from about 0.1:1 to about 10:1, or from about 0.2:1 to about 5:1. For compositions comprising a combination of hydrogen peroxide and ionic silver, the weight ratio of hydrogen peroxide to ionic silver may be from about 5:1 to about 300:1, or from about 10:1 to about 250:1 or from about 20:1 to about 200:1. Weight ratios between components of the disclosed compositions may depend on a number of factors, including desired benefits and the optional adjuncts present in the composition.

The composition(s) disclosed herein may comprise surfactant and antimicrobial active, where the antimicrobial active comprises hydrogen peroxide and the surfactant comprises from about 6 to about 12 carbon atoms, and where the weight ratio of the surfactant to the hydrogen peroxide is from about 0.1:1 to about 10:1.

The compositions disclosed herein may comprise ionic silver, hydrogen peroxide, or mixtures thereof in combination with an unregistered (North America) or unnotified (Europe) acidifying agent. The compositions disclosed herein may comprise ionic silver, hydrogen peroxide, or mixtures thereof in combination with a registered (North America) or notified (Europe) acidifying agent. The compositions disclosed herein may comprise benzoic acid, citric acid, glycolic acid, hypochlorous acid, lactic acid, octanoic acid, peroxyacetic acid, hydrogen peroxide, ionic silver, or mixtures thereof (which are US EPA and Health Canada registered antimicrobial actives). Benzoic acid, citric acid, lactic acid, hydrogen peroxide, and certain ionic silver compounds, such as silver nitrate, are also approved for use for water treatment or on food contact surfaces in the USA. Additionally, citric acid, 1-lactic acid, ethanol, isopropanol, sodium bisulfate and hydrogen peroxide are the only antimicrobial approved actives for the US EPA's Design for the Environment (DfE) pesticide pilot project. Lactic acid, citric acid, peroxyoctanoic acid, and hydrogen peroxide are also notified substances in the European Union. These certifications may provide important credentialing options for the compositions disclosed herein.

### Adjuncts

The compositions disclosed herein may also contain one or more adjuncts. Adjuncts may be employed to increase immediate and/or residual efficacy of the compositions, improve the wetting characteristics of the compositions upon application to a target substrate, operate as solvents for diluted compositions, and/or serve to modify the aesthetic characteristics of the composition. These adjuncts may also provide degreasing and solubilizing benefits, additional antimicrobial potentiation, thickening, soil agglomeration or soil release benefits, enhanced composition solubility, further catalysis of antimicrobial activity, residual or long-lasting (e.g., 24 hours) duration antimicrobial properties and/or enhanced surface safety benefits.

The composition(s) disclosed herein may comprise an adjunct selected from the group consisting of chelants, builders, buffers, abrasives, electrolytes, bleaching agents, fragrances, dyes, foaming control agents, corrosion inhibitors, essential oils, thickeners, pigments, gloss enhancers, enzymes, detergents, solvents, dispersants, polymers, silicones, hydrotropes, and mixtures thereof.

### Solvents

The composition(s) disclosed herein may comprise a solvent (in addition to the amide of formula I, which may also function as a solvent). Solvents are generally liquid at ambient temperature conditions. The compositions disclosed herein may comprise from about 0.25% to about 25%, or from about 0.5% to about 15%, or from about 1% to about 10% of solvent by weight of the composition. Solvents may be used to control suds, adjust composition viscosity, or provide additional antimicrobial potentiation. Solvents may also be used to improve cleaning or prevent components of the composition from crystallizing out. Non-limiting examples of solvents that may improve cleaning include glycol ethers, more specifically C₁-C₈ derivatives of mono-, di-, and triethylene glycol ethers and diethers, and the C₁-C₆ derivatives of mono-, di- and tripropylene glycol ethers and diethers. Non-limiting examples include propylene glycol propyl ether, dipropylene glycol butyl ether, diethylene glycol butyl ether, tripropylene glycol dimethyl ether, ethylene glycol n-hexyl ether, ethylene glycol n-octyl ether, and the like. “Butyl” includes normal butyl, isobutyl and tertiary butyl groups. The solvent may be chosen to be non-VOC (Volatile Organic Compound), as defined by the California Air Resources Board, or VOC, e.g., ethanol, isopropanol and propylene glycol. A VOC solvent may be present at a concentration of less than about 0.5% by weight of the in-use composition.

The composition(s) disclosed herein may comprise a solvent selected from the group consisting of ethanol, isopropanol, C₁-C₈ monoethylene glycol ether, C₁-C₈ diethylene glycol ether, C₁-C₈ triethylene glycol ether, C₁-C₆ monopropylene glycol ether, C₁-C₆ dipropylene glycol ether, C₁-C₆ tripropylene glycol ether, C₁-C₆ esters of formic acid, C₁-C₆ esters of acetic acid, C₁-C₆ esters of benzoic acid, C₁-C₆ esters of lactic acid, C₁-C₆ esters of 3-hydroxybutyric acid, C₁-C₆ amines, C₁-C₆ alkanol amines, and mixtures thereof. Examples of commercially available ethylene glycol-based solvents include Hexyl Cellosolve™ (ethylene glycol n-hexyl ether, C6 monoethylene glycol) and Butyl Carbitol™ (diethylene glycol n-butyl ether, C4 diethylene glycol) sold by Dow Chemical Company. Examples of commercially available propylene glycol-based solvents include Dowanol DPnB™ (dipropylene glycol n-butyl ether, C4 dipropylene glycol) and Dowanol TPM™ (tripropylene glycol methyl ether, C1 tripropylene glycol), which are also available from the Dow Chemical Company.

The composition(s) disclosed herein may comprise from about 1% to about 10% of a solvent selected from the group consisting of glycerol, diethylene glycol monoethyl ether, butyl 3-hydroxybutyrate, and mixtures thereof. Incorporation of diethylene glycol monoethyl ether, a non-VOC compound, may help solubilize highly crystalline and substantially water-insoluble materials, such as benzoic acid (acidifying agent) and octanohydroxamic acid (amide of formula I). Incorporation of diethylene glycol monoethyl ether may also improve freeze-thaw stability of the composition, particularly for compositions comprising benzoic acid, and/or octanohydroxamic acid, which are substantially water-insoluble, highly crystalline materials that may precipitate out or crystallize out when a composition is cooled during the freeze process or warmed during the thaw process.

For composition(s) having a pH of about 2.5 or greater, or a pH of about 3.0 or greater, an ester-based solvent may improve cleaning. Non-limiting examples of ester-based solvents include C₁-C₆ esters of formic acid, C₁-C₆ esters of acetic acid, C₁-C₆ esters of lactic acid, C₁-C₆ esters of citric acid, C₁-C₆ esters of succinic acid, and C₁-C₆ esters of 3-hydroxybutyric acid. The composition may comprise butyl 3-hydroxybutyrate (Omnia™ solvent, available from Eastman), which may provide a boost in cleaning performance, especially for greasy soils. Butyl 3-hydroxybutyrate may also help solubilize highly crystalline and substantially water-insoluble materials and promotes the freeze-thaw stability of the composition (particularly a composition comprising benzoic acid and/or octanohydroxamic acid).

### Essential Oils

Suitable essential oils or actives thereof include those essential oils which exhibit antimicrobial activity. By “actives of essential oils” it is meant any ingredient of essential oils that exhibits antimicrobial activity. Essential oils and actives thereof may also provide a desirable odor profile.

Suitable essential oils include, but are not limited to, those obtained from thyme, lemongrass, citrus, lemons, oranges, anise, clove, aniseed, cinnamon, geranium, roses, mint, lavender, citronella, eucalyptus, peppermint, camphor, sandalwood, cedar, or mixtures thereof.

Actives of essential oils include, but are not limited to, thymol (present, for example, in thyme), eugenol (present, for example, in cinnamon and clove), menthol (present, for example, in mint), geraniol (present, for example, in geranium and rose), verbenone (present, for example, in vervain), eucalyptol and pinocarvone (present in eucalyptus), cedrol (present, for example, in cedar), anethol (present, for example, in anise), carvacrol, hinokitiol, berberine, terpineol, limonene, or mixtures thereof. The compositions disclosed herein may comprise thymol. Thymol is commercially available, for example, from Sigma Aldrich.

### Chelants

The compositions disclosed herein may comprise one or more chelants or sequestrants. As used herein, the terms “chelant” and “sequestrant” are used interchangeably. Chelants include chemical compounds that sequester alkali earth metal divalent ions, transition metal divalent ions, and/or transition metal trivalent ions from solution. The metal ions to be sequestered may be present in the compositions disclosed herein (for example, incorporated via hard water used in a dilution) or may be embedded within the microorganism that the composition is intended to treat. Metal ions in the concentrated compositions disclosed herein may originate from impurities in the water or in the raw materials used to make the compositions. These metal ions may adversely affect performance or composition stability. The concentration of metal ions may be reduced using processes to purify water, including reverse osmosis and de-ionization. Examples of such metal ions include the divalent and trivalent ions of iron, nickel, manganese, and the like.

Metal ions associated with a microorganism may be important for the functioning and survival of microorganism. The metal ions may be extracellular or they may be intracellular; the metal ions may be present, for example, at the active site of metabolic or regulatory enzymes or as a cofactor that enables enzymatic activity. Examples of metal ions associated with a microorganism include iron, copper, zinc and magnesium ions, and the like.

Highly water-soluble chelants may be used to sequester metal ions present in the composition. Lipophilic chelants may be used to target the metal ions associated with a microorganism. The composition(s) disclosed herein may comprise a mixture of hydrophilic and lipophilic chelants.

The composition(s) disclosed herein may comprise up to about 10%, by weight of the composition, or from about 1% to about 10% of chelant. The chelant may comprise one or more phosphorus atoms. Non-limiting examples of phosphorous-containing chelants include 1-hydroxyethylidene-1,1-diphosphonic acid (HEDP, also known as etidronic acid), diethylene triamine penta(methylene phosphonic acid), 2-phosphonobutane-1,2,4-tricarboxylic acid (PBTC), and the like. The chelant may be a nil-phosphorus chelant. Non-limiting examples of nil-phosphorus chelants include the sodium, potassium, and alkanolamine salts of nitrilotriacetic acid (NTA), methyl glycine diacetic acid (MGDA), glutamic N,N-diacetic acid (GLDA), ethylene diamine tetraacetic acid (EDTA), diethylene triamine pentaacetic acid (DTPA), iminodisuccinic acid (IDS), ethylenediamine N,N′-disuccinic acid (EDDS), 4,5-dihydroxy-1,3-benzene disulfonic acid (Tiron), 2-hydroxypyridine N-oxide (HPNO), octyl isothiazolinone (OIT), picolinic acid, dipicolinic acid, 1-hydroxy-4-methyl-6-(2,4,4-trimethylpentyl) pyridine-2-one (piroctone acid), and the like. 2-hydroxypyridine N-oxide (HPNO) may be employed for chelation as well as for reducing precipitation or crystallization of crystalline components, such as benzoic acid or octanohydroxamic acid.

The composition(s) disclosed herein may comprise from about 1% to about 10% of a chelant selected from the group consisting of diethylene triamine pentaacetic acid (DTPA), iminodisuccinic acid, ethylenediamine N,N′-disuccinic acid, 4,5-dihydroxy-1,3-benzene disulfonic acid, octyl isothiazolinone, picolinic acid, dipicolinic acid, 2-hydroxypyridine N-oxide, and mixtures thereof.

The weight ratio of chelant to amide of formula I (when the amide is other than hydroxamic acid) may be from about 1:30 to about 1:3, or from about 1:20 to about 1:5. Incorporation of one or more chelants into the compositions disclosed herein may provide additional potentiation benefits, further supplementing the activity of the amide of formula I, particularly at greater composition pHs (e.g., pH about 3 to about 6 or pH about 4 to about 6).

### Wipe or Pad

The present invention also relates to an article of manufacture comprising said composition, wherein the composition is comprised in a spray dispenser, or in a wipe or pad. The composition can be comprised on a wipe or pad. Such wipes and pads can be suitable for treating hard surfaces, such as found in the household, and the like. Suitable wipes can be fibrous. Suitable fibrous wipes can comprise polymeric fibres, cellulose fibres, and combinations thereof. Suitable cellulose-based wipes include kitchen wipes, and the like. Suitable polymeric fibres include polyethylene, polyester, and the like. Polymeric fibres can be spun-bonded to form the wipe. Methods for preparing thermally bonded fibrous materials are described in U.S. application Ser. No. 08/479,096 (Richards et al.), filed Jul. 3, 1995 (see especially pages 16-20) and U.S. Pat. No. 5,549,589 (Homey et al.), issued Aug. 27, 1996 (see especially Columns 9 to 10). Suitable pads include foams and the like, such as HIPE-derived hydrophilic, polymeric foam. Such foams and methods for their preparation are described in U.S. Pat. No. 5,550,167 (DesMarais), issued Aug. 27, 1996; and commonly assigned U.S. patent application Ser. No. 08/370,695 (Stone et al.), filed Jan. 10, 1995.

### Methods of Use

The compositions disclosed herein may be used in a variety of applications and methods, including the treatment of hard surfaces, the treatment of soft inanimate surfaces, and the treatment of skin. The compositions may be used in the home to clean, sanitize, disinfect or sterilize hard surfaces, such as counters, sinks, restrooms, toilets, bath tubs, shower stalls, kitchen appliances, floors, windows, walls, furniture, phones, toys, drains, pipes, and the like. The compositions may also be used in commercial establishments, such as hotels, hospitals, care homes, eating establishments, fitness centers, schools, office buildings, department stores, and prisons, to clean, sanitize, disinfect, or sterilize equipment, tools, food and medical preparation areas (in addition to the surfaces mentioned above that are common to both homes and commercial establishments). The compositions disclosed herein may be used to treat indoor as well as outdoor surfaces and may also be used to sanitize, disinfect, or sterilize soft inanimate surfaces, such as carpets, area rugs, curtains, upholstery, and clothes, in both the home or in commercial settings.

The compositions may be used to treat bacteria, non-enveloped or enveloped viruses, fungi, spores, or allergens on surfaces or in the air. The compositions may also be used to purify contaminated water. The compositions may also be used in agricultural applications in the treatment of weeds, fruits, plants, and animals, including cattle and horses, as well as carcasses. The compositions may be used to disinfect or sanitize indoor or outdoor non-food, indirect food, or food contact agricultural premises, buildings, including animal housing, pens, feed troughs, greenhouses, storage containers and the like. The compositions may be used to sanitize or disinfect equipment used in non-food, indirect food, or food contact indoor and outdoor settings, including equipment used in green houses (with or without ornamental or food crops), feed handling, hatcheries, ice dispensing, processing livestock feeding, milk processing, milking, mushroom houses, poultry processing or handling, transport vehicles, and the like. The antimicrobial compositions, especially when formulated at a pH ranging from about 3.5 to about 6.0, may also be used to disinfect human skin.

### EXAMPLES

Methods:

A) pH measurement:

The pH is measured on the neat composition, at 25° C., using a pH meter with compatible gel-filled pH probe (such as Sartarius PT-10P meter with Toledo probe part number 52 000 100), calibrated according to the instructions manual.

C) Antibacterial Efficacy (Minimum Biocidal Concentration in suspension):

The antimicrobial efficacy of the composition is determined by measuring its Minimum Biocidal Concentration (MBC). The MBC is defined as the lowest absolute concentration of the composition which provides complete kill (zero bacterial growth). The MBC of the compositions herein is determined against two (2) bacteria, gram-positive cocci and known opportunistic skin pathogen, Staphylococcus aureus (S. aureus—ATCC #6538) and gram-negative biofilm producer and drug resistant bacterium, Klebsiella pneumoniae (K. pneumoniae—ATCC #4352) This microorganisms are representative of natural contaminants in many consumer and industrial applications. The bacteria inoculum is prepared by transferring several colonies from a Tryptone Soy Agar (TSA) plate to a saline solution (0.85% NaCl), the bacteria concentration in this saline solution is determined by turbidimetric measurements. Before turbidimetric measurements, the spectrophotometer was adjusted to 100% transmittance (0% absorbance) bu using a sample of uninoculated saline solution. Percent transmittance of the dilutions of the bacterial culture was measured and the values converted to optical density (O.D), based on the formula: Absorbance (O.D.)=2-log % Transmittance. A wavelength of 425 nm is used when the solution is clear, 540 nm when the solution is light yellow, and 600-625 nm is used for yellow to brown solutions. Both bacteria culture dilute solutions of S. aureus—ATCC #6538 and K. pneumoniae—ATCC #4352 were clear and wavelength of 425 was chosen. The % Transmittance at 425 nm was adjusted by either adding more bacteria or more saline solution until the % Transmittance at 425 nm is between 23-25% which corresponds to O.D of 0.6021-0.6383 equivalent to bacteria concentration of 10⁸ CFU/ml.

200 μL of the composition was dosed into one well of row A of a 96 well microtiter plate. Each subsequent well (rows B to G) were dosed with 100 μL of the same hard surface cleaning composition, without the addition of the antimicrobial agent. 100 μL of the antimicrobial hard surface cleaning composition was transferred from row A to row B and mixed. 100 μL of the composition was then transferred from row B to row C and mixed, and the process repeated to row G. As such, the concentration of the antimicrobial agent underwent two-fold dilution in adjacent wells, while the concentration of the other actives in the hard surface cleaning composition were constant across all the wells in the same column.

10 μL of the 10⁸ CFU/ml bacteria suspension in saline was added to wells A to F of the microtiter plate with row G kept as a nil bacteria control. The final volume in each well is 110 μL, except for row G which comprised 100 μL of the hard surface cleaning composition and no bacteria suspension. Bacterial inoculation to each column was staggered by 30 seconds to allow for equal incubation times in all columns so that the contact time between the bacteria and the antimicrobial active for all samples was 6 mins. After this contact time, 10 μL of each test solution was transferred to 90 μL of neutraliser solution (Modified Letheen Broth+1.5% Polysorbate 80, supplied by BioMérieux) to stop the antimicrobial action of the antimicrobial active. 2 μL of this solution was plated onto a TSA plate matching the stagger of the inoculation so that all samples are exposed to the neutralizer for the same period of time. The plate is incubated at 32.5° C. for 18-24 h. MBC concentration is taken as the lowest concentration of the antimicrobial active at which no visible colony growth is observed on the TSA plate.

### Example 1

| | Composition (wt. %) | | | | | | | | | |
|---|---|---|---|---|---|---|---|---|---|---|
| | #1 | #2 | #3 | #4 | #5 | #6 | #7 | #8 | #9 | #10 |
| C8AS | 6 | 6 | 6 | 6 | 6 | 6 | 6 | 6 | 6 | 6 |
| Lactic acid | 6 | 6 | 6 | 6 | 6 | 6 | — | — | — | — |
| Succinic acid | — | — | — | — | — | — | 5 | — | 5 | — |
| Citric acid | — | — | — | — | — | — | — | 6 | — | 6 |
| Unsat. C10 DMA | — | — | 6 | — | — | — | — | — | — | — |
| amide | | | | | | | | | | |
| sat. C10 DMA | — | — | — | 6 | — | 6 | — | — | — | — |
| amide | | | | | | | | | | |
| sat. C12 DMA | — | 6 | — | — | — | — | — | — | 6 | 6 |
| amide | | | | | | | | | | |
| Hydrogene | — | — | — | — | 4.5 | 4.5 | — | — | — | — |
| Peroxyde | | | | | | | | | | |
| De-ionized water | To 100 | To 100 | To 100 | To 100 | To 100 | To 100 | To 100 | To 100 | To 100 | To 100 |
| pH | 1.90 | 2.18 | 2.21 | 2.26 | 1.98 | 2.84 | 2.5 | 2.5 | 2.5 | 2.5 |

Product dilution at which greater than 99.9% microbial reduction is achieved

| Composition # | Gram (+) | Gram (−) |
|---|---|---|
| #1 | 1/64 | 1/64 |
| #2 | 1/4096 | 1/4096 |
| #3 | 1/4096 | 1/4096 |
| #4 | 1/4096 | 1/4096 |
| #5 | 1/512 | 1/1024 |
| #6 | 1/4096 | 1/4096 |
| #7 | 1/16 | 1/32 |
| #8 | 1/32 | 1/128 |
| #9 | 1/4096 | 1/4096 |
| #10 | 1/4096 | 1/4096 |

The most effective compositions achieve greater than 99.9% microbial reduction with most dilute compositions (1/4096). This product dilution translates into the product concentrations shown in the table below

Product concentration (ppm) required
for >99.9% microbial reduction

| Composition # | Gram (+) | Gram (−) |
|---|---|---|
| #1 | 15625 | 15625 |
| #2 | 244.14 | 244.14 |
| #3 | 244.14 | 244.14 |
| #4 | 244.14 | 244.14 |
| #5 | 1953 | 976 |
| #6 | 244.14 | 244.14 |
| #7 | 3125 | 1562 |
| #8 | 937.5 | 937.5 |
| #9 | 12.2 | 12.2 |
| #10 | 14.65 | 14.65 |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of treating a fabric, the method comprising contacting the fabric with an aqueous liquor comprising a surfactant; an acidifying agent; an amide of formula I:
R¹—CO—NR²R³ (I)
wherein R¹ is selected from the group consisting of linear or branched, substituted or unsubstituted C₆-C₁₂, each of R² and R³ is independently selected from H, OH, a halogen, or C₁-C₆ linear or branched, substituted or unsubstituted hydrocarbyl groups; optionally an antimicrobial active; and water; wherein said liquor has a pH from about 3.0 to about 6.5.

2. A method according to claim 1 wherein said liquor has a pH from about 3.5 to about 6.

3. A method according to claim 1 wherein the aqueous liquor is formed by adding to water a composition comprising the surfactant; the acidifying agent; the amide of formula I:
R¹—CO—NR²R³ (I)
wherein R¹ is selected from the group consisting of linear or branched, substituted or unsubstituted C₆-C₁₂, each of R² and R³ is independently selected from H, OH, a halogen, or C₁-C₆ linear or branched, substituted or unsubstituted hydrocarbyl groups; water; and optional antimicrobial active; wherein said composition has a pH from about 1 to about 6.

4. A method according to claim 1 wherein the aqueous liquor is formed by adding to water a composition comprising the surfactant; the acidifying agent; the amide of formula I:
R¹—CO—NR²R³ (I)
wherein R¹ is selected from the group consisting of linear or branched, substituted or unsubstituted C₆-C₁₂, each of R² and R³ is independently selected from H, OH, a halogen, or C₁-C₆ linear or branched, substituted or unsubstituted hydrocarbyl groups; water; and optional antimicrobial active; wherein said composition has a pH from about 2.5 to about 5.0.

5. A method according to claim 1 wherein the antimicrobial active is selected from ionic silver, an active oxygen source., or mixtures thereof.

6. A method according to claim 1 wherein the antimicrobial active is hydrogen peroxide.

7. A method according to claim 1 wherein said surfactant comprises from about 6 to about 12 carbon atoms.

8. A method according to claim 1 wherein said surfactant is selected from the group consisting of C₈ glyceryl ether sulfonate, C₂-C₈ linear alkyl benzene sulfonate, C₆-C₁₂ alkyl sulfate, C₈-C₁₂, methyl ester sulfonate, C₈-C₁₂, fatty acid sulfonate, C₆-C₁₂ alkylethoxy carboxylate, C₆-C₁₂ alkylethoxy sulfate, C₈₋₁₀ dimethyl amine oxide, C₈ pyrrolidone, C₈ dimethyl betaine, C₈₋₁₀ alkyl polyglycoside, C₈₋₁₂N,N-dimethyl-3-ammonio-1-propanesulfonate, and mixtures thereof.

9. A method according to claim 1 wherein said acidifying agent is selected from the group consisting of formic acid, acetic acid, benzoic acid, malonic acid, citric acid, maleic acid, fumaric acid, hypochlorous acid, succinic acid, gluconic acid, glutaric acid, lactic acid, 2-ethyl-1-hexanoic acid, cinnamic acid, heptanoic acid, octanoic acid, nonanoic acid, peracetic acid, peroctanoic acid, undecylenic acid, lactic acid, salicylic acid and mixtures thereof.

10. A method according to claim 1 wherein said amide of formula I is selected from the group consisting of N,N-dimethyl octanamide, N,N-dimethyl decanamide, N,N-dimethyl 9-decenamide, N,N-dimethyl 7-octenamide, octanohydroxamic acid, and mixtures thereof.

11. A method according to claim 1, wherein said composition comprises a solvent selected from the group consisting of ethanol, isopropanol, C₁-C₈ monoethylene glycol ether, C₁-C₈ diethylene glycol ether, C₁-C₈ triethylene glycol ether, C₁-C₆ monopropylene glycol ether, C₁-C₆ dipropylene glycol ether, C₁-C₆ tripropylene glycol ether, C₁-C₆ esters of formic acid, C₁-C₆ esters of acetic acid, C₁-C₆ esters of benzoic acid, C₁-C₆ esters of lactic acid, C₁-C₆ esters of 3-hydroxybutyric acid, C₁-C₆ amines, C₁-C₆ alkanol amines, and mixtures thereof.

12. A method according to claim 1 wherein in said amide of formula I, IV is selected from the group consisting of linear or branched, substituted or unsubstituted C₆-C₁₀ hydrocarbyl groups.

13. A method according to claim 1 comprising antimicrobial active and wherein the weight ratio of said acidifying agent to said antimicrobial active is from about 0.2:1 to about 5:1.

14. A method according to claim 1 comprising antimicrobial active and wherein the weight ratio of said surfactant to said antimicrobial active is from about 0.1:1 to about 10:1.

15. A method according to claim 1 comprising antimicrobial active and wherein the weight ratio of said antimicrobial active to said amide of formula I is from about 0.2:1 to about 5:1.

16. A method according to claim 1 wherein the aqueous liquor is formed by adding to water a composition comprising the surfactant; the acidifying agent; the amide of formula I:
R¹—CO—NR²R³ (I)
wherein R¹ is selected from the group consisting of linear or branched, substituted or unsubstituted C₆-C₁₂, each of R² and R³ is independently selected from H, OH, a halogen, or C₁-C₆ linear or branched, substituted or unsubstituted hydrocarbyl groups; water; and optional antimicrobial active; wherein said composition has a pH from about 1 to about 6, wherein said composition comprises from about 0.01% to about 30% of an antimicrobial active.

17. A method according to claim 1 wherein the aqueous liquor is formed by adding to water a composition comprising the surfactant; the acidifying agent; the amide of formula I:
R¹—CO—NR²R³ (I)
wherein R¹ is selected from the group consisting of linear or branched, substituted or unsubstituted C₆-C₁₂, each of R² and R³ is independently selected from H, OH, a halogen, or C₁-C₆ linear or branched, substituted or unsubstituted hydrocarbyl groups; water; and optional antimicrobial active; wherein said composition has a pH from about 1 to about 6, wherein said composition has a critical micelle concentration from about 100 ppm to about 2,500 ppm.

18. A method according to claim 1 wherein the aqueous liquor is formed by adding to water a composition comprising the surfactant; the acidifying agent; the amide of formula I:
R¹—CO—NR²R³ (I)
wherein R¹ is selected from the group consisting of linear or branched, substituted or unsubstituted C₆-C₁₂, each of R² and R³ is independently selected from H, OH, a halogen, or C₁-C₆ linear or branched, substituted or unsubstituted hydrocarbyl groups; water; and optional antimicrobial active; wherein said composition has a pH from about 1 to about 6, wherein said composition comprises from about 0.03% to about 25% of said acidifying agent.

19. A method according to claim 1 wherein the aqueous liquor is formed by adding to water a composition comprising the surfactant; the acidifying agent; the amide of formula I:
R¹—CO—NR²R³ (I)
wherein R¹ is selected from the group consisting of linear or branched, substituted or unsubstituted C₆-C₁₂, each of R² and R³ is independently selected from H, OH, a halogen, or C₁-C₆ linear or branched, substituted or unsubstituted hydrocarbyl groups; water; and optional antimicrobial active; wherein said composition has a pH from about 1 to about 6, wherein said composition comprises from about 0.03% to about 25% of said amide of formula I.

20. A method according to claim 1 wherein the fabric is contacted with the aqueous liquor having a pH from about 3.0 to about 6.5, and comprising a surfactant; an acidifying agent; an amide of formula I:
R¹—CO—NR²R³ (I)
wherein R1 is selected from the group consisting of linear or branched, substituted or unsubstituted C6-C12, each of R2 and R3 is independently selected from H, OH, a halogen, or C1-C6 linear or branched, substituted or unsubstituted hydrocarbyl groups; and optionally antimicrobial active, in a rinse-step of a fabric laundering process.

21. A method according to claim 1 wherein the fabric is contacted with the aqueous liquor in a pre-treat step of a fabric laundering process.

22. A method according to claim 1 wherein the fabric is contacted with the aqueous liquor in a washing machine rinse cycle and/or pre-treat cycle.
